(19) United States
(12) Patent Application Publication
(10) Pub. No.: US 2008/0120403 A1
(43) Pub. Date: May 22, 2008

(54) Systems and Methods for Provisioning Homogeneous Servers

(75) Inventors: James Craig Lowery, Austin, TX (US); Mark Andrew Collins, Dripping Springs, TX (US); Brent Schroeder, Austin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/562,921

(22) Filed: Nov. 22, 2006

(51) Int. Cl. G06F 15/173

(52) U.S. Cl. 709/223

(57) ABSTRACT

The present disclosure relates to a system for provisioning homogeneous servers comprising an image repository coupled to a plurality of servers through an internet protocol (IP) networks wherein the image repository comprises a base virtual disk file. The system may further comprise a logical virtual disk file instance for each of the servers which created a least one change to the base virtual disk file.

### BACKGROUND

1. Technical Field

The present disclosure relates generally to information handling systems and particularly to the provisioning of homogeneous servers.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more IHS, data storage systems, and networking systems.

“Server provisioning” is the process of placing an software, such as operating software, device drives, middleware and/or applications onto an information handling system and particularly, to server hardware. This task can be cumbersome when there are many servers (hundreds or thousands) to provision. One particular variation of the provisioning problem is when the servers will have the same software installed. For example, these “homogeneous” servers occur in High Performance Compute Clusters, in which hundreds of servers run the same software that cooperatively solves a problem by breaking it down into smaller parts. Server software homogeneity also occurs with server farms, such as banks of web servers.

The main problem with provisioning large farms or clusters of N servers with the same software is that the software stack (or “image”) must be replicated a number (N) of times. Current technologies either copy the image N times across the network to the local disks of the systems, or the user must create N copies of the same SCSI LUN on a fiber channel SAN to enable “boot from SAN” diskless provisioning. This copying may be time consuming, and the driver setup for boot from SAN is non-trivial. Generally, LUN (logical unit number) is used in SCSI and iSCSI parlance to mean a logical unit name or number. It refers to the name of the disk as an IHS would find it on the network.

Traditional image copy has been implemented by multiple vendors function by maintaining a library of images and copying them to the hard disks of the individual target servers. The primary drawback of these systems is that they incur a large penalty for image copy across the network, and they are quite complex in the rules they must apply to an image to prepare it for use on different target configurations.

PXE boot is an example of image copy, but using a “pull” method (server requests an image from the network). PXE is often used as the first stage in a traditional image copy solution, in which PXE is used to load the “pre-boot environment” within which the imaging application will execute. PXE is itself a useful tool for creating a provisioning process, but by itself may not be adequate.

“Boot From SAN” (BFS) is a widely deployed technology that allows a server to be “diskless” and boot from a storage area network. iSCSI boot is itself an extension of the BFS concept. BFS only provides for being diskless and accessing an image on a staging storage device. It does not address image management or replication.

A similar rapid provisioning effect can be created by using server virtualization software. A virtualization platform may be installed onto every server in the farm. Afterwards, virtual machines can be “provisioned” onto a virtual server using virtual disk files to contain the image, and either copying that virtual disk file to the server's local storage, or by the virtual server accessing the virtual disk file over a fibre channel or Ethernet network. This method has the drawback that there is still a provisioning step in which the virtualization software itself must be installed on every server in the farm, and updated with patches, etc., thereafter.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

A system for provisioning homogeneous servers is disclosed herein. The system may include an image repository coupled to a plurality of servers through an internet protocol (IP) network, wherein the image repository comprises a base virtual disk file. The system may further include a logical virtual disk file instance for each of the servers which created a least one change to the base virtual disk file.

Also disclosed is a method of provisioning homogeneous target servers with virtual disks files. The method may include providing access for a plurality of servers to access a base virtual disk file and providing a logical instance for each of the plurality of servers to make a change to the base virtual disk file.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 depicts a non-limiting embodiment of the system of the present disclosure

FIG. 2 depicts a non-limiting embodiment of a method of the present disclosure,

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal IHS, a network storage device, or any other suitable device and may vary in size, shape, performance, functionality, and price. The IHS may include random access memory (RAM), one or more processing resources such as a central processing unit (CPU) or hardware or software control logic: ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

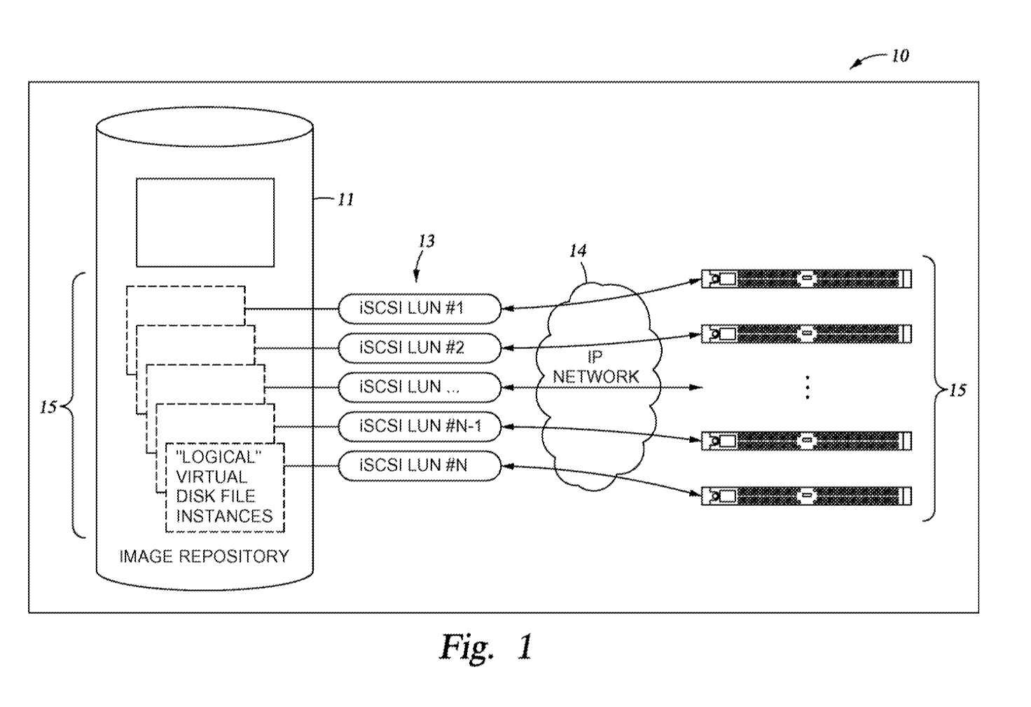

As shown in FIG. 1, the system 10 comprises an image repository 11 having a base file 16 and virtual disk file instances 12. Each virtual disk file instance 12 is associated with a iSCSI LUN 13, which provides an address to one of N servers 15 on an IP network 14. Each server 15 has diskless iSCSI boot and is configured with a unique iSCSI target LUN, which it then boots. FIG. 1 shows how a base disk image 16 can be logically replicated (i.e., without full copy) to multiple disks using copy on write, a functionality embedded in the virtual disk files.

One element of the present disclosure is iSCSI, and in particular iSCSI boot. This allows the ability to point a IHS across the network to a disk (and to a particular part of the disk) using iSCSI and boot from it. A disc local to the IHS is not required. In an illustrative embodiment, the present disclosure provides for iSCSI boot with virtual disc files that have copy on write ability.

iSCSI is a transport layer protocol in the SCSI-3 specification. The iSCSI protocol uses TCP/IP for its data transfer. Unlike other network storage protocols, iSCSI may require only the simple Ethernet interface (or any other TCP/IP-capable network) to operate. This enables low-cost centralization of storage without the usual expense and incompatibility normally associated with Fibre Channel area networks.

iSCSI host bus adapters (HBAs) are network interface controllers that incorporate a TCP Offload Engine with onboard iSCSI processing. iSCSI HBAs have the advantage of including PCI option ROMS to allow booting from iSCSI targets. Alternative iSCSI boot methods with software initiators may require substantial work.

The internet protocol suite is the set of communications protocols that implement the protocol stack on which the internet and most commercial networks run. It is sometimes called the TCP/IP protocol suite, after the two most important protocols in it: the transmission control protocol (TCP) and the internet protocol (IP), which were the also the first two defined.

TCP is one of the core protocols of the internet protocol suite. Using TCP, applications on networked hosts can create connections to one another, over which they exchange data in formatted blocks of information carried by a IHS network. IHS communications links that do not support blocks, such as traditional point-to-point telecommunications links, simply transmit data as a series of bytes, characters or bits alone. When data is transmitted as formatted blocks, the network can transmit longer messages more efficiently and reliably. The protocol guarantees reliable and in-order delivery of data from sender to receiver. TCP also distinguishes data for multiple connections by concurrent applications (e.g., web server and e-mail server) running on the same host.

“Copy on write” is an optimization strategy used in programming. The fundamental idea is that if multiple callers ask for resources which are initially indistinguishable, they are given pointers to the same resource rather than a separate copy of the resource. This fiction can be maintained until a caller tries to modify its “copy” of the resource, at which point a true private copy is created to prevent the changes becoming visible to all callers. Alt of this happens transparently to the callers. The primary advantage is that if a caller never makes any modifications, no private copy need ever be created. Copy on write is a policy that may be used for caching technologies or for caching implementation. Typically, disks that IHSs use are broken down into blocks. Each of the IHSs executing an image from a disk over iSCSI is reading blocks across iSCSI. As long as the IHSs only read and do not write to the blocks, all the IHSs can read the same blocks from one image that they share. However, when one of the IHSs makes an update to the block and the IHS writes back an updated block with changes to it, the updated block cannot be used to change the master image because the other IHSs that are sharing that block did not make that update. The other IHSs are still operating from the original block copy. A duplicate of the block is made, the updates from that particular IHS are written to this new block, and any time that particular IHS requests that block, that particular IHS gets the block that was created for it with those changes. The other IHSs continue to read the original copy of the block when the IHSs do their reads unless they also make a change for themselves.

Continuing with FIG. 1 the image repository 11 is a file stored on a server. The image repository 11 may contain the base virtual disk file 16 and this facility is able to take the file and create multiple instances 12 of it logically. It gives N names (iSCSI LUNS 13) and allows those names to be available on the IP network 14. The method by which those names are published or made available is are understood by one of skill in the art but are outside the scope of the disclosure.

Each of the individual N IHSs receives a different iSCSI target LUN 13 from which to boot. When an IHS sends requests across the IP network 14, such requests are going to the same location, image repository 11 on server. The image repository maps all the IHS requests to the same base file 16. However, the image repository 11 keeps up with any writes that occur. If a read comes in for disk 87, block No. 10, the image repository will determine if there have been any previous writes to disk 87 for block 10. If there has been a write to disk 87, block No. 10, as in the example above, then the image repository 11 retrieves disk 87's version of block No. 10 and sends it via an IP network to IHS No. 87.

If a request comes in from an IHS to perform a write, such event triggers the creation of a logical block. As writing is done by the various IHSs to their respective iSCSI LUNs 13, the writes will come in with a disk identifier, the target name, along with the block the IHS is writing to, and the image repository 11. The image repository 11 will perform a copy on write to change the contents of the block. The image repository 11 will also, over time, build up additional blocks that are modified blocks to the base file.

The image repository does not make N copies of the base file 16. The only way the image repository 11 would have N copies of the base file is if each of the N IHSs wrote to each block of the base file. However, this scenario is very unlikely to occur, because most of the IHSs on the IP network 14 read much more frequently then the IHSs write and because operating system code tends to be fairly static.

Each target server 15 is endowed with an iSCSI boot solution. The solution can be an iSCSI HBA, or a combination of iSCSI-aware NIC, OS and BIOS. The iSCSI boot mechanism for each target server is assigned one of the unique iSCSI target LUNS of the exposed virtual disk file. A NIC (network interface card) may be hardware designed to allow IHSs to communicate over a network.

An OS (operating system) is a software program that manages the hardware and software resources of a IHS. As a component of system software, the OS performs basic tasks, such as controlling and allocating memory, prioritizing the processing of instructions, controlling input and output devices, facilitating networking, and managing files. BIOS (basic input/output system or basic integrated operating system) refers to the software code run by an IHS when first powered on. The primary function of BIOS is to prepare the IHS so that other software programs stored on various media (such as hard drives, floppies, and CDs) can load, execute, and assume control in a process is known as booting up.

The method of configuring the servers 15 with iSCSI boot LUN information can be done manually, or can be performed by a directory-ware boot firmware, which can query an LDAP directory such as Active Directory to retrieve LUN assignments placed there by the same management software that created the iSCSI target LUNS.

A LDAP (lightweight directory access protocol) directory is a networking protocol for querying and modifying directory services running over TCP/IP. By way of example, Active Directory is a commercial implementation of LDAP directory services. Active Directory allows administrators to assign enterprise-wide policies, deploy programs to many IHSs, and apply critical updates to an entire organization. Active Directory may also store information and settings relating to an organization in a central, organized, accessible database.

In an embodiment, the present disclosure combines two existing technologies—iSCSI (in particular iSCSI boot) and virtual disk files—to rapidly provision homogeneous servers. The present disclosure may allow for the ability to assign an iSCSI target LUN to a virtual disk file, ability for virtual disk files to be replicated logically (without full copy) using copy on write and the ability to boot a physical server using iSCSI.

The present disclosure may also allow for quickly creating multiple logical instances of a single virtual disk file without the need for complete replication of the disk file. “Copy on write” is used such that, if multiple servers 15 have mounted a virtual disk file 16, there is only one instance of each block in the file so long as it is never written by any server 15. When a server 15 writes a block into the virtual disk file 12, the block is replicated and associated with that server and updated with its changes. In this way, each server's 15 perceived disk is a composite of the base virtual disk file and the differences captured by the block copies.

The present disclosure further allows a virtual disk file to be associated with an iSCSI target LUN that is published to the network. This iSCSI target may appear similar to any other iSCSI target. However, the only difference is that the backing store is a virtual disk file, not a physical disk.

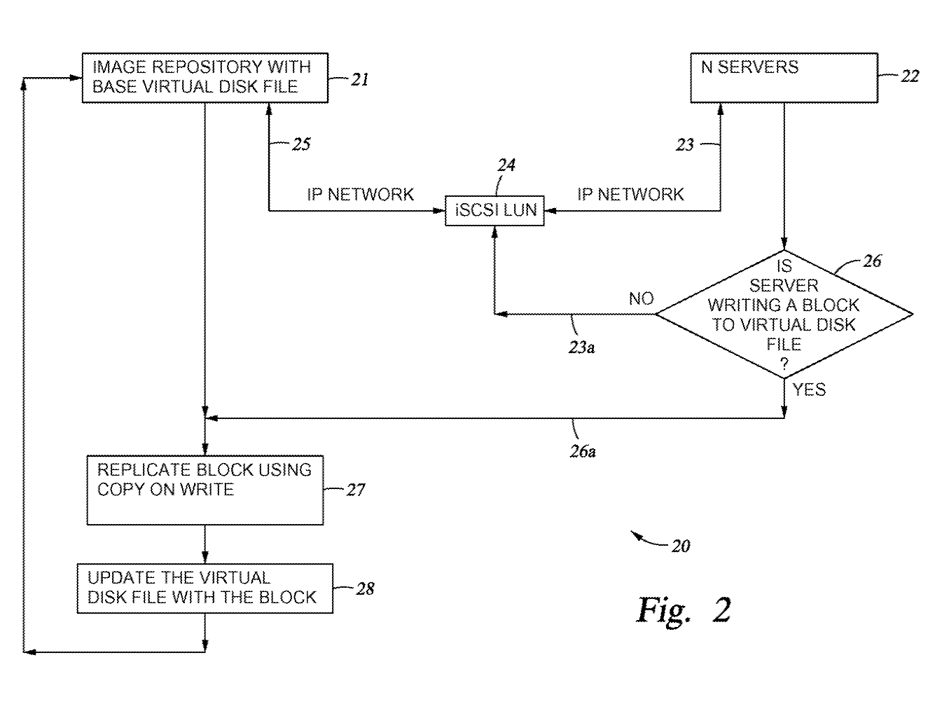

The following description of one possible embodiment of the present disclosure, as illustrated in FIG. 2, is set forth, for the purpose of explanation and not limitation. During normal operation, a server 22 performs an iSCSI boot 23 (and 23a) and, using an iSCSI LUN 24, may access a virtual disk file from the image repository 21. The image repository 21 publishes unique target LUNS to an IP network 25. Occasionally, a server 22 may write a block to a virtual disk file (see 26 and 26a). The image repository 21 processes this block by replicating the block associated with the server using copy on write 27. Then, the image repository 21 updates the virtual disk with the block 28 such that the server's virtual disk is a composite of the base virtual disk file and the updated block.

while various embodiments have been shown and described, various modifications and substitutions may be made thereto without departing from the spirit and scope of the invention. Accordingly, it is to be understood that the present invention has been described by way of illustrations and not limitation.

What is claimed is:

1. A system for provisioning homogeneous servers, comprising:
an image repository coupled to a plurality of servers through an internet protocol (IP) network, wherein the image repository comprises a base virtual disk file, and
a logical virtual disk file instance for each of the servers which created a least one change to the base virtual disk file.

2. The system of claim 1 wherein a virtual disk file of each server is a composite of the base virtual disk file and a block of change is created by said server.

3. The system of claim 2, wherein the block is replicated with a copy on write procedure.

4. The system of claim 1, wherein each server is configured with a unique iSCSI target LUN, which it then boots.

5. The system of claim 2, wherein each virtual disk file is associated with a unique target LUN and published to the IP network.

6. The system of claim 1 wherein the iSCSI boot solution is an iSCSI HBA.

7. The system of claim 1, wherein the iSCSI boot solution is a combination of iSCSI-aware NIC, OS, and BIOS.

8. The system of claim 4, wherein the servers are manually configured with iSCSI boot LUN information.

9. The system of claim 4, wherein the servers are configured with iSCSI boot LUN information with a directory-aware boot firmware which can query a LDAP directory to retrieve LUN assignments placed there by the same management software that created the iSCSI target LUNS.

10. A system for provisioning homogeneous servers, comprising:
a plurality of homogeneous servers, each server having a diskless iSCSI boot solution and LUN;
an image repository coupled to the servers through an iP network, wherein the image repository comprises a base virtual disk file; and
a logical virtual disk file instance for each of the servers which created a least one change to the base virtual disk file.

11. The system of claim 10, wherein the iSCSI boot solution is an iSCSI HBA.

12. The system of claim 110, wherein the iSCSI boot solution is a combination of iSCSI-aware NIC, OS, and BIOS.

13. The system of claim 10, wherein the servers are manually configured with iSCSI boot LUN information.

14. The system of claim 10, wherein the servers are configured with iSCSI boot LUN information with a directory-aware boot firmware which can query a LDAP directory to retrieve LUN assignments placed there by the same management software that created the iSCSI target LUNS.

15. A method of provisioning homogeneous target servers with virtual disks files, comprising the steps of:
providing access for a plurality of servers to access a base virtual disk file; and
providing a logical instance for each of the plurality of servers to make a change to the base virtual disk file.

16. The method of claim 16, further comprising:
assigning each virtual disk file with a unique target LUN; and
publishing the unique target LUNS to an IP network;

17. The method of claim 16, further comprising;
manually configuring the servers with iSCSI boot LUN information.

18. The method of claim 16, further comprising:
configuring the servers with iSCSI boot LUN information using a directory-aware boot firmware which can query an LDAP directory to retrieve LUN assignments placed there by the same management software that created the target LUNS.
